(19) United States
(12) Patent Application Publication
(10) Pub. No.: US 2007/0069003 A1
(43) Pub. Date: Mar. 29, 2007

(54) Boring device and boring method

(76) Inventors: Teruie Takemasu, Fukuoka (JP); Ichiki Terashima, Aichi (JP)

Correspondence Address: WENDEROTH, LIND & PONACK, L.L.P., 2033 K STREET N. W., SUITE 800, WASHINGTON, DC, 20006-1021, US

(21) Appl. No.: 10/575,550

(22) PCT Filed: Oct. 14, 2004
(86) PCT No.: PCT/JP04/15164

§ 371 Date: Apr. 10, 2006

(30) Foreign Application Priority Data
Oct. 22, 2003 (JP) 2003-362168

(51) Int. Cl. G06K 1/00

(52) U.S. Cl. 234/1

(57) ABSTRACT

A boring such as a high accuracy boring is performed by inputting vibration only in the moving direction of a tool. The device comprises an ultrasonic horn (1) functioning as a vibrator, a punch (2) functioning as a boring tool for boring a work (W) which is an object to be bored, a guide bush (3) guiding the punch (2) in the moving direction, an elastic body (4) for retaining the punch (2) in a floating state on the guide bush (3), and a die (5) functioning as the boring tool formed in pairs with the punch (2). The punch (2) is floatingly retained by the elastic body (4) inside the guide bush (5), and vibration is applied to the punch (2) by the ultrasonic horn (1) to make the punch (2) jump toward the work (W) to strike the work (W) for boring the work (W).

### TECHNICAL FIELD

The present invention relates to a boring device that uses vibrations, such as ultrasonic waves, to bore an object to be bored as well as a boring method.

### BACKGROUND ART

Conventionally, boring an object to be bored has been performed by press work or electrical discharge. There are problems however with press work having poor hole accuracy and electrical discharge having high costs. In view of these, ultrasonic machining that uses ultrasonic vibrations is known as a method that can perform boring operations with high accuracy and low costs.

As described in Patent Document 1, when using ultrasonic vibration to bore, a tool is directly mounted to an ultrasonic vibrator unit and the boring is performed while continuously applying ultrasonic vibrations to the tool. Patent Reference 1 further discloses the ability to perform ultrasonic machining on holes with very small diameters by mounting a tool with good vertical accuracy to an ultrasonic vibrator unit.

Patent Document 1: Unexamined Japanese Patent Publication No. Hei 7-136818

### DISCLOSURE OF THE INVENTION

### Problems to be Solved by the Invention

Even though the tool directly mounted to the ultrasonic vibrator as described in Patent Document 1 applies longitudinal ultrasonic vibration waves in the moving direction of the tool, the vibrations continuously being input are too fast compared to the moving speed of the tool. Because of this, transverse vibration waves are inevitably input to the tool. Consequently, the tool that receives these transverse vibration waves moves and comes into contact with the sidewall of the bored hole, damaging the surface of the sidewall of the hole.

An object of the present invention is to provide a boring device and a boring method that can perform high accuracy boring.

### Means to Solve the Problems

A boring device of the present invention comprises: a boring tool; a guide for restricting a moving direction of this boring tool; a vibrator for applying vibrations to the boring tool to make the boring tool jump; and a float retention member for retaining the boring tool in a floating state at a specified position and for generating a restoration force to return the boring tool at least up to a position where it comes into contact with the vibrator when the boring tool is displaced from the specified position. It should be appreciated that the boring performed in the present invention includes not only a through hole formed by a punching process but also a blind hole with a bottom formed by an extrusion process.

As the vibrator, an ultrasonic horn that converges ultrasonic waves generated by an ultrasonic vibrator and generates ultrasonic vibrations from the tip thereof, a piezoelectric actuator that utilizes inertial force accompanied by rapid deformations of a piezoelectric device or an electrostrictive device to generate very small vibrations, a device that applies repeated impacts by means of an indirect impact tool such as a so-called hammer punch in which a hammer strikes a punch to transfer the impact force of the hammer through the punch utilizing the inertia, and the like can be used.

According to the boring device of the present invention, the boring tool retained in a floating state at a specified position is made to jump by applying a vibration from the vibrator, separate from the vibrator, and strike the object to be bored while the moving direction is restricted by the guide. Since the boring tool is separated from the vibrator at this time, it vibrates in the moving direction, applying the force of the moving direction to the struck object to be bored and thereby performing the boring operation.

The boring tool that strikes the object to be bored is returned at least up to a position where it comes into contact with the vibrator by a restoring force of the float retention member or to the original specified position before the tool jumped, for example, and once again receives vibrations from the vibrator and jumps. In other words, the boring tool repeatedly separates from the vibrator and strikes the object to be bored, thereby repeatedly boring the object to be bored.

Hereupon, the boring device of the present invention is preferably equipped with a pressing device that presses the vibrator towards the boring tool. In this case, because the vibrator applies vibrations while the tool is pressed towards the object to be bored and then jumps towards the object, the boring tool has a small throw up to the object to be bored. Consequently, the boring tool gradually bores the object to be bored while moving back and forth between the vibrator and the object to be bored with an amplitude smaller than the former case.

### ADVANTAGE OF THE INVENTION

According to the present invention, the boring tool is retained in a floating state at a specified position inside the guide that restricts the moving direction thereof, the vibrator applies vibrations to the boring tool to make the boring tool jump towards the object to be bored and then make the boring tool strike the object to be bored, and the boring tool displaced from the specified position is returned at least up to a position where the boring tool comes into contact with the vibrator. This makes it possible to perform a boring operation using the boring tool applying vibrations to the object to be bored in the moving direction. Because of this, shifting outside the moving direction of this boring tool can be prevented and a highly accurate boring operation can be obtained.

In addition, making the boring tool jump while being pressed towards the object to be bored reduces the throw of the boring tool up to the object to be bored and the boring tool gradually bores the object to be bored while moving back and forth between the vibrator and the object to be bored at a small amplitude, thereby reducing the impact force applied to the tip of the boring tool. This makes it possible to extend the life of the boring tool.

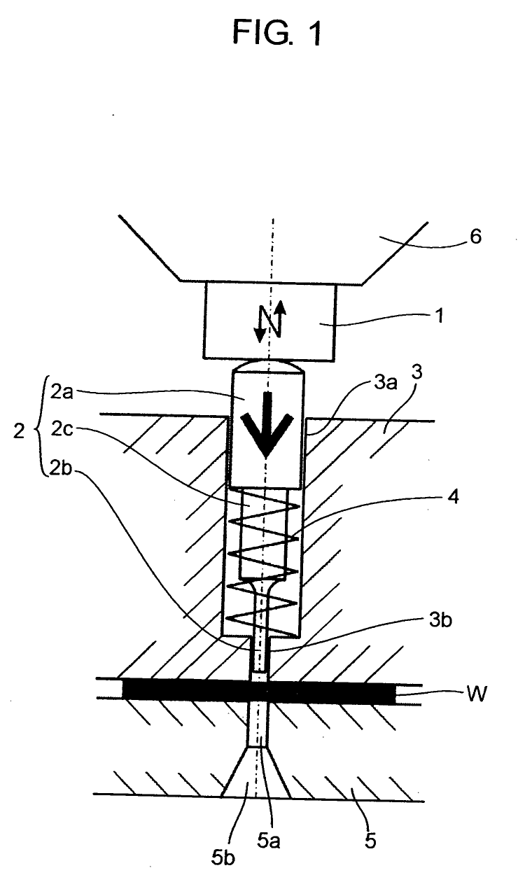

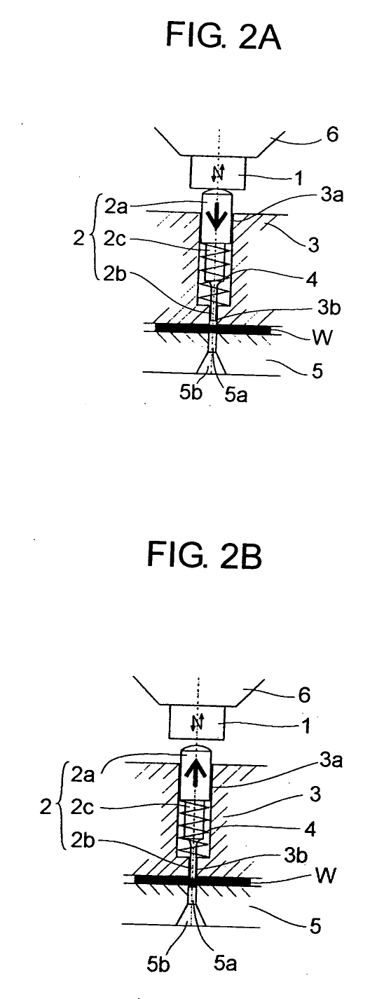

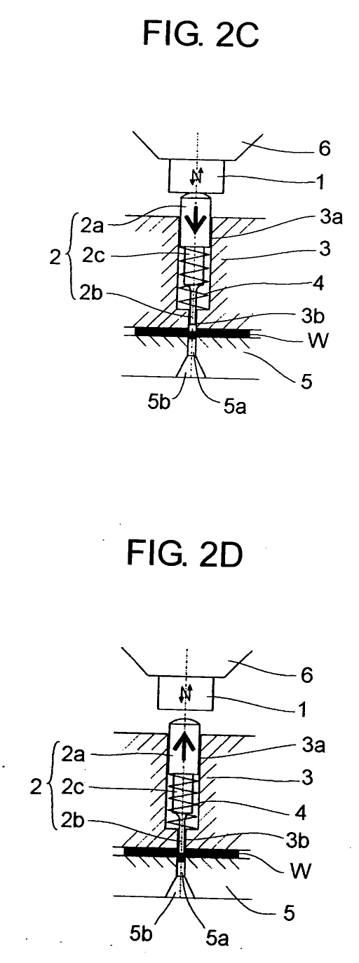

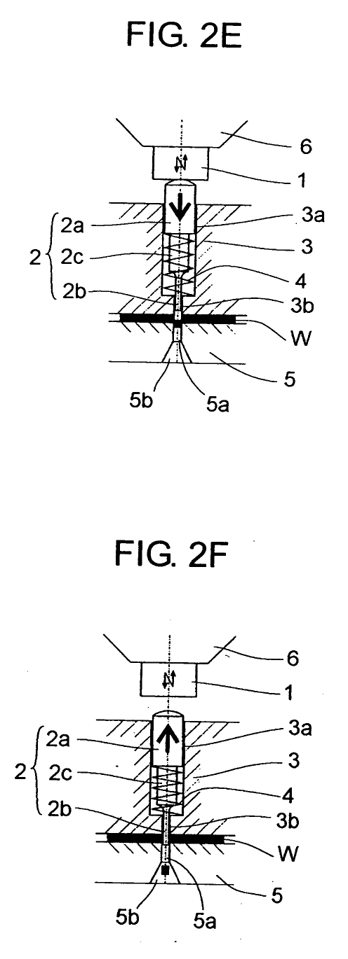

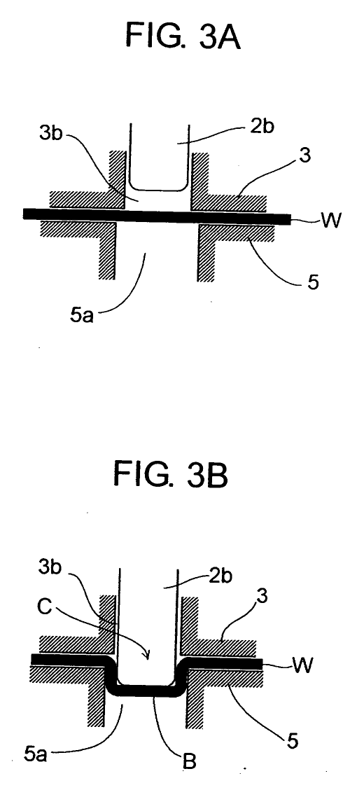

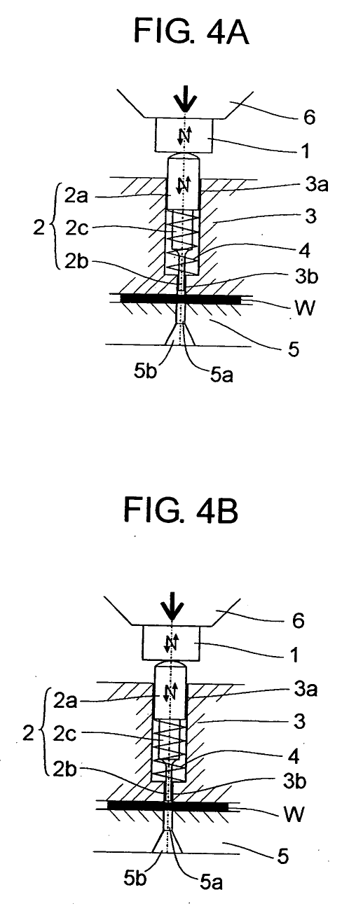

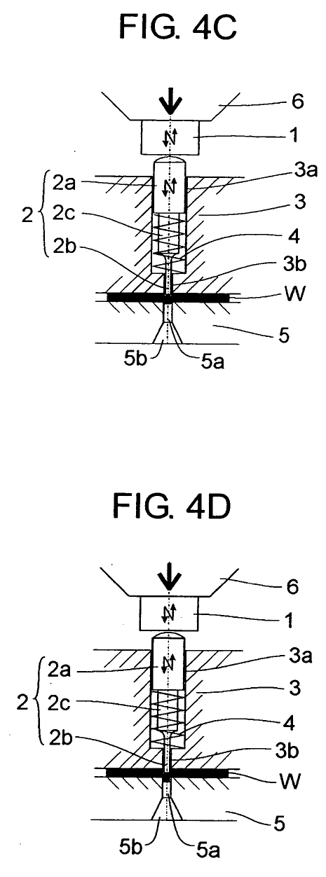

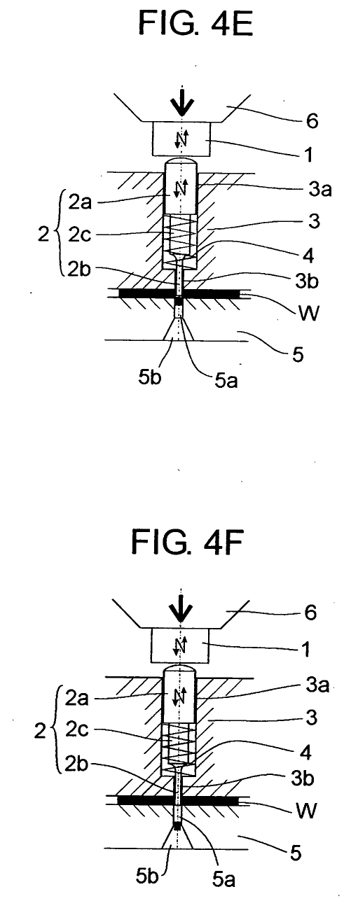

### BRIEF DESCRIPTION OF THE DRAWINGS

[FIG. 1] is an outlined cross section illustrating the boring device in one embodiment of the present invention.

[FIG. 2A] illustrates the boring process using the boring device of FIG. 1.

[FIG. 2B] illustrates the boring process using the boring device of FIG. 1.

[FIG. 2C] illustrates the boring process using the boring device of FIG. 1.

[FIG. 2D] illustrates the boring process using the boring device of FIG. 1.

[FIG. 2E] illustrates the boring process using the boring device of FIG. 1.

[FIG. 2F] illustrates the boring process using the boring device of FIG. 1.

[FIG. 3A] is an enlarged view of the contact area between a punch and a work; the figure also illustrates the boring process when forming a blind hole with a bottom.

[FIG. 3B] is an enlarged view of the contact area between a punch and a work; the figure also illustrates the boring process when forming a blind hole with a bottom.

[FIG. 4A] illustrates the boring process accompanied by a pressing action using a pressing device.

[FIG. 4B] illustrates the boring process accompanied by a pressing action using the pressing device.

[FIG. 4C] illustrates the boring process accompanied by a pressing action using the pressing device.

[FIG. 4D] illustrates the boring process accompanied by a pressing action using the pressing device.

[FIG. 4E] illustrates the boring process accompanied by a pressing action using the pressing device.

[FIG. 4F] illustrates the boring process accompanied by a pressing action using the pressing device.

### DESCRIPTION OF THE REFERENCE NUMERALS

1: ultrasonic hone

2: punch

2a: head

2b: processing portion

2c: body shank

3: guide bush

3a, 3b: guide hole

4: elastic body

5: die

5a: boring hole

6: pressing device

### BEST MODE FOR CARRYING OUT THE INVENTION

FIG. 1 is an outlined cross section illustrating the boring device in one embodiment of the present invention, and FIGS. 2A to F show the boring process using the boring device of FIG. 1.

As shown in FIG. 1, the boring device in this embodiment comprises: a ultrasonic horn 1 that functions as a vibrator; a punch 2 that functions as a boring tool that bores a work W which is an object to be bored; a guide bush 3 that guides the punch 2 in a moving direction; an elastic body 4 that functions as a float retention member to retain the punch 2 in a floating state on the guide bush 3; a die 5 that functions as a boring tool formed in pairs with the punch 2; and a pressing device 6 that presses the ultrasonic horn 1 towards the die 5 or the work W.

The ultrasonic horn 1 converges ultrasonic waves generated by an ultrasonic vibrator (not shown) and generates ultrasonic vibrations from a tip thereof. The ultrasonic horn 1 and the punch 2 are not fixed. Because of this, when vibrations are applied to a back end (a head 2a) of the punch 2 by the ultrasonic horn 1, the punch 2 jumps and moves separating from the ultrasonic horn 1.

The punch 2 has the head 2a whereon vibrations are applied by the ultrasonic horn 1, a processing portion 2b that comes into contact with the work W to perform the boring, and a body shank 2c that connects the head 2a and the processing portion 2b. The punch 2 is retained in a floating state at a specified position (position shown in FIG. 2A) by the elastic body 4 provided between the head 2a and the guide bush 3.

The area where the head 2a of the punch 2 comes into contact with the ultrasonic horn 1 has an arc surface as shown in FIG. 1. If both of the ultrasonic horn 1 and the punch 2 coming into contact with each other have flat surfaces and if either of the surfaces is slightly sloped, partial contact will occur and it will become difficult for the punch 2 to strike downward in a straight direction. In contrast to this, if the head 2a of the punch 2 has an arc surface or more preferably a spherical surface, the head 2a of the punch 2 and the ultrasonic horn 1 always come into contact at a point close to the center axis of the punch 2 and it becomes easier for the punch 2 to strike downward in a straight direction. The shape of the cross section of the tip of the processing portion 2a of the punch 2 can be any shape such as a circular shape, a blade shape, a square shape, a triangle shape, or an oval shape.

The elastic body 4 has a restoration force that returns at least to a position where contact is made with the ultrasonic horn 1 and as an example to the specified position shown in FIG. 2A. This restoration force returns the punch 2 that has been displaced from the specified position to the specified position. The elastic body 4 comprises a spring (plate spring, coil spring, spiral spring, air spring, or rubber), a damper, or a combination of these for example.

The die 5 holds the work W along with the punch 2. In addition, the die 5 has a boring hole 5a that corresponds to the processing portion 2b of the punch 2 and a tapered hole 5b communicating with the boring hole 5a. The tapered hole 5b expands in a boring direction, that is, in a direction from an area connected to the boring hole 5a towards a lower side (open side) of the die 5. This tapered hole 5b easily discharges punch scraps generated after the processing downward and makes it difficult for the punch scraps to clog the hole.

The guide bush 3, in order to restrict the moving direction of the punch 2, has a cylindrical guide hole 3a inside of which the head 2a of the punch 2 slides and a cylindrical guide hole 3b inside of which the processing portion 2b of the punch 2 slides. The operation of the body shank 2c of the punch 2 is restricted to only in an axial direction using these guide holes 3a and 3b. The elastic body 4 described above is arranged between a lower end of the guide hole 3a and the head 2a of the punch 2.

The head 2a of the punch 2, the body shank 2c, the processing portion 2b, and the guide holes 3a and 3b of the guide bush 3 are formed in a stepped shape with the diameter becoming smaller towards the boring direction of the punch 2. The-purpose of this shape is to adjust the mating at the head 2a of the punch 2 with the largest diameter and the guide hole 3a as well as to provide play in the processing portion 2b and the guide hole 3b. The reason for providing play in the processing portion 2b and the guide hole 3b is to prevent the tip of the processing portion 2b from damaging due to deformation such as bending or buckling caused by excessive stress received.

The elastic body 4 is also retained so as to be held between the stepped portion between the head 2a and the body shank 2c of the punch 2 and the stepped portion of the guide holes 3a and 3b. This type of retained state makes it possible to retain the punch 2 in a floating state by the simplest structure. Although not shown in the figure, the punch 2 can be retained in a floating state by providing an elastic body on the outside of the guide holes 3a and 3b.

In a plastic processing device having the structure described above, when the ultrasonic horn 1 generating ultrasonic vibration waves is brought into contact with the head 2a of the punch 2 as shown in FIG. 2A, ultrasonic vibration waves from the ultrasonic horn 1 are applied to the punch 2 and the punch 2 separates from the ultrasonic horn 1 jumping towards the work W. At this time the operation of the head 2a and the processing portion 2b of the punch 2 is restricted to only in the axial direction by the guide holes 3a and 3b of the guide bush 3. Accordingly, the punch 2 moves straight towards the work W without swinging from side to side and then arrives at the work W.

Thereafter, as shown in FIG. 2B, the restoration force of the elastic body 4 makes the punch 2 jump towards the ultrasonic horn 1 and then as shown in FIG. 2C, return to the initial position of the punch 2. Further, the punch 2 receives an application of ultrasonic vibration waves from the ultrasonic horn 1 once again and jumps towards the work W. When the punch 2 arrives at the work w as shown in FIG. 2D, the restoration force of the elastic body 4 once again makes the punch 2 jump towards the ultrasonic horn 1 and be returned.

In this manner the punch 2 is repeatedly separated from the ultrasonic horn 1 and strikes the work W (refer to FIGS. 2D and 2E). Thus, the work W undergoes high accuracy boring by the repetitive force received from the punch 2 (refer to FIG. 2F).

In the above-mentioned embodiment, whereas as an example of forming a through hole by a punching process was described as an example of a boring process, a blind hole with a bottom can also be formed by an extrusion process using this boring device. FIG. 3A and FIG. 3B are enlarged views of the contact area between the punch 2 and the work W and illustrate the boring process when forming a blind hole with a bottom.

In like manner to above, the operation to apply vibrations using the ultrasonic horn 1 and to make the processing portion 2b of the punch 2 (that jumped) repeatedly strike the work W as shown in FIG. 3A repeats and the work W is extruded towards the boring hole 5a of the die 5 as shown in FIG. 3B. The blind hole C provided with the bottom B is formed by this operation.

In the above-mentioned embodiment, whereas an example was described in which the boring process was performed with the position of the ultrasonic horn 1 fixed and the pressing device 6 not driven during the boring process, the process can also be performed while pressing the ultrasonic horn 1 towards the work W using this pressing device 6 during the boring process.

FIGS. 4 A to F illustrate the boring process accompanied by a pressing action using the pressing device 6.

In this case, at first, the ultrasonic horn 1 and the punch 2 are statically pressed by the pressing device 6 until the tip of the body shank 2c of the punch 2 comes into contact with the upper surface of the work W as shown in FIG. 4A and FIG. 4B. Next, the ultrasonic horn 1 applies ultrasonic vibration waves to the punch 2 while the pressing device 6 is pressing (refer to FIG. 4C).

At this time, the punch 2 separates from the ultrasonic horn 1, jumps towards the work W, jumps back to the ultrasonic horn 1 by the restoration force of the elastic body 4, and then comes into contact with the ultrasonic horn 1. The punch 2 repeats this operation to perform high accuracy boring on the work W (refer to FIG. 4D, FIG. 4E, and FIG. 4F). Since the punch 2 jumps while being pressed towards the work W by the pressing device 6, the distance up to the work W is short.

Consequently, the punch 2 gradually bores the work W at a small amplitude while moving back and forth between the ultrasonic horn 1 and the work W. Since this reduces the impact force applied to the tip of the punch 2, the life of the punch 2 can be extended. When the work W is made of a fibrous material, a thick material, or a composite material, it is preferable to perform the process while the pressing device 6 presses the ultrasonic horn 1 towards the work W.

The pressing speed of the pressing device 6 is approximately the plate thickness (mm)×0.05−the plate thickness (mm)×5 (/second). In other words, when the plate thickness is 1 mm, the speed is most preferably 0.05 to 5 mm/second. The ultrasonic frequency is approximately 20 to 80 kHz and the optimum ultrasonic frequency is 40 kHz. Although the ultrasonic wave output will greatly change depending on the material of the work W, the optimum output is approximately 50 to 1000 W. For example, the output is approximately 500 to 800 W with a 0.5 to 1.0 mm thick steel plate and approximately 200 to 400 W with a 0.1 mm thick foil.

### INDUSTRIAL APPLICABILITY

The present invention is useful as a device and a method to bore an object to be bored utilizing vibrations such as ultrasonic waves. In particular, the present invention is suitable for high accuracy boring processes.

1. A boring device comprising:
a boring tool;
a guide for restricting a moving direction of the boring tool;
a vibrator for applying ultrasonic vibrations to the boring tool to make the boring tool jump; and
a float retention member for retaining the boring tool in a floating state at a specified position and for generating a restoration force to return the boring tool at least up to a position where the boring tool comes into contact with the vibrator when the boring tool is displaced from the specified position.

2. The boring device according to claim 1, wherein the float retention member returns the boring tool to the specified position when the boring tool is displaced from the specified position.

3. The boring device according to claim 1, comprising a pressing device for pressing the vibrator towards the boring tool.

4. The boring device according to claim 1, wherein the vibrator repeatedly applies the ultrasonic vibrations to the boring tool.

5. The boring device according to claim 2, wherein the vibrator repeatedly applies the ultrasonic vibrations to the boring tool.

6. The boring device according to claim 3, wherein the vibrator repeatedly applies the ultrasonic vibrations to the boring tool.

7. A boring method for boring an object to be bored comprising:
retaining a boring tool in a floating state at a specified position inside a guide that restricts a moving direction;
applying ultrasonic vibrations to the boring tool using a vibrator to make the boring tool jump towards the object to be bored;
making the boring tool strike the object to be bored; and
returning the boring tool having been displaced from the specified position at least up to a position where the boring tool comes into contact with the vibrator.

8. The boring method according to claim 7, wherein the boring tool having been displaced from the specified position is returned to the specified position.

9. The boring method according to claim 7, wherein when the vibrator applies ultrasonic vibrations to the boring tool to make the boring tool jump towards the object to be bored, the boring tool is made jump while being pressed towards the object to be bored.

10. The boring method according to claim 7, wherein the vibrator repeatedly applies the ultrasonic vibrations to the boring tool.

11. The boring method according to claim 8, wherein the vibrator repeatedly applies the ultrasonic vibrations to the boring tool.

12. The boring method according to claim 9, wherein the vibrator repeatedly applies the ultrasonic vibrations to the boring tool.
